(19) United States
(12) Patent Application Publication
(10) Pub. No.: US 2009/0144081 A1
(43) Pub. Date: Jun. 4, 2009

(54) METHODS AND SYSTEMS FOR DYNAMIC MEAL PLAN GENERATION

(76) Inventor: Timothy S. Harlan, New Orleans, LA (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/247,680

(22) Filed: Oct. 8, 2008

Related U.S. Application Data
(60) Provisional application No. 60/978,281, filed on Oct. 8, 2007.

(51) Int. Cl. G06Q 50/00; G06Q 99/00

(52) U.S. Cl. 705/2; 705/1

(57) ABSTRACT

Provided are methods and systems for dynamic meal plan generation comprising determining meal plan servings, receiving meal plan factors, selecting recipes in accordance with the meal plan factors, and outputting the selected recipes as a meal plan.

### CROSS REFERENCE TO RELATED PATENT APPLICATION

This application claims priority to U.S. Provisional Application No. 60/978,281 filed Oct. 8, 2007, herein incorporated by reference in its entirety.

### SUMMARY

Provided are methods and systems for dynamic meal plan generation comprising determining meal plan servings, receiving meal plan factors, selecting recipes in accordance with the meal plan factors, and outputting the selected recipes as a meal plan. Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 illustrates an input screen for exemplary user information;

FIG. 3 illustrates an input screen for exemplary meal plan factors;

FIG. 4 illustrates an exemplary client/server architecture within which the present methods can be practiced;

FIG. 5 illustrates an exemplary method for dynamic meal plan generation;

FIG. 6 illustrates exemplary lunch guidelines;

FIG. 7 illustrates an exemplary meal plan; and

FIG. 8 illustrates an exemplary shopping list.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting. As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

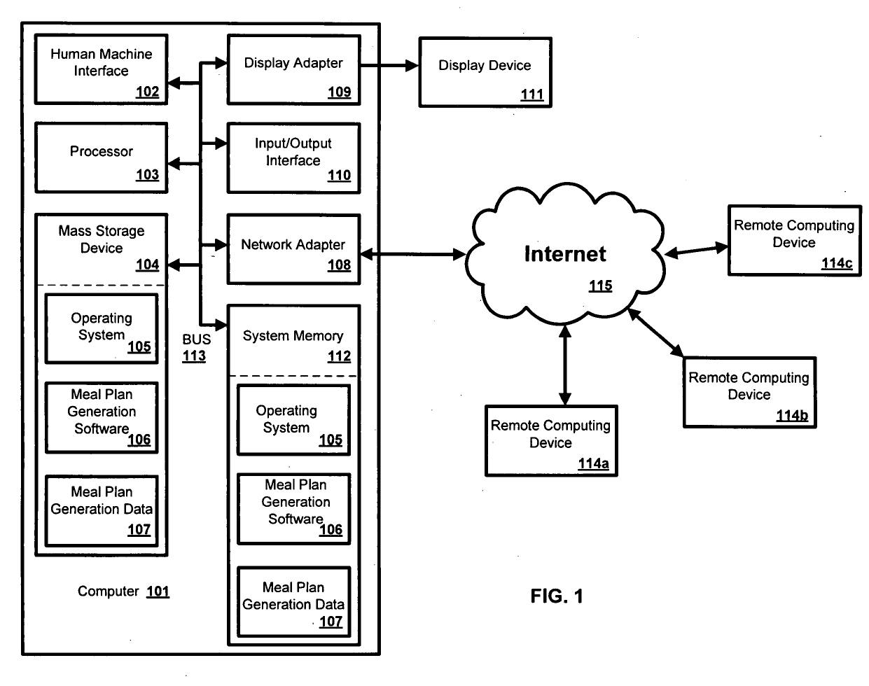

One skilled in the art will appreciate that provided is a functional description and that the respective functions can be performed by software, hardware, or a combination of software and hardware. FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, meal plan generation software 106, meal plan generation data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as meal plan generation data 107 and/or program modules such as operating system 105 and meal plan generation software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and meal plan generation software 106. Each of the operating system 105 and meal plan generation software 106 (or some combination thereof) can comprise elements of the programming and the meal plan generation software 106. Meal plan generation data 107 can also be stored on the mass storage device 104. Meal plan generation data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

The system can provide various administrative functions. These functions can include, but are not limited to, user administration, recipe editing, ingredient editing, adding/deleting recipes, adding/deleting ingredients. In an aspect, recipe entry can permit automatic calculation of Nutrition Facts and storage in the system. Nutrition information can be calculated based on the USDA National Nutrient Database for Standard Reference.

The system can support administrative functions such as database entry of any data discussed herein, including but not limited to, recipes, recipe tagging, equipment requirements, and the like. In one aspect, provided is a database configured for storing, for example, recipe information. Recipe information can include, but is not limited to, Title, Page Path, Serving Size (SVG), Number of Servings, Multiply By (MULT), Cooking Time, Divisible by (DIV), Left Over Text, Quote/Open Field, Refrigerator Light/Recipe Opinion, Left Over Properties, Ingredient Information, and the like. Recipes in the database can be tagged with labels to facilitate operations. Examples of recipe tags include, but are not limited to, leftovers (such as, LO-leftover for dinner, LOS-leftover for lunch, LOB-leftover for breakfast, and SVG-number of servings in a particular recipe), scale properties (such as, DIV-Is the recipe divisible? and MULT-What can the recipe be multiplied by), recipe type (such as, BMF-breakfast Monday through Friday, BW-breakfast weekend, L-lunch (can be ½ dinner leftover), D<45-dinner recipe taking<45 minutes to cook, and D>45-Dinner recipe taking>45 minutes to cook), side dishes (such as, SWB-item to be served with breakfast, SWS-starch recipe that is served with dinner, and SWV-vegetable dish recipe that is served with dinner), recipe type (such as, RED-Red meat recipe, FISH-Fish recipe, SHEL-Shellfish recipe, POUL-Poultry recipe, MTLS-Meatless recipe, VEGN-Vegan, VEGL-Lacto-ovo vegetarian, COMF-Comfort Food), health properties (such as, COUM-Coumadin (warfarin) user, GERD-Gastroesophageal Reflux Disease, DIAB-Diabetes, SOD-Low-sodium, GOUT-Gout, PREG-Pregnancy, CANC-Cancer, RENL-Renal Failure Diet, IBS-Irritable Bowel Syndrome), allergies (such as, LACT-Recipe Contains Lactose, CHEESE-Recipe Contains Cheese or fermented dairy only, GLUT-Recipe Contains Gluten, FISH-Recipe Contains Fish, SHEL-Recipe Contains Shellfish, PNUT-Contains Peanuts, TREE-Contains Tree Nuts, SOY-Contains Soy Products), and equipment requirements (such as, utensils, cooking devices, container sizes, and the like).

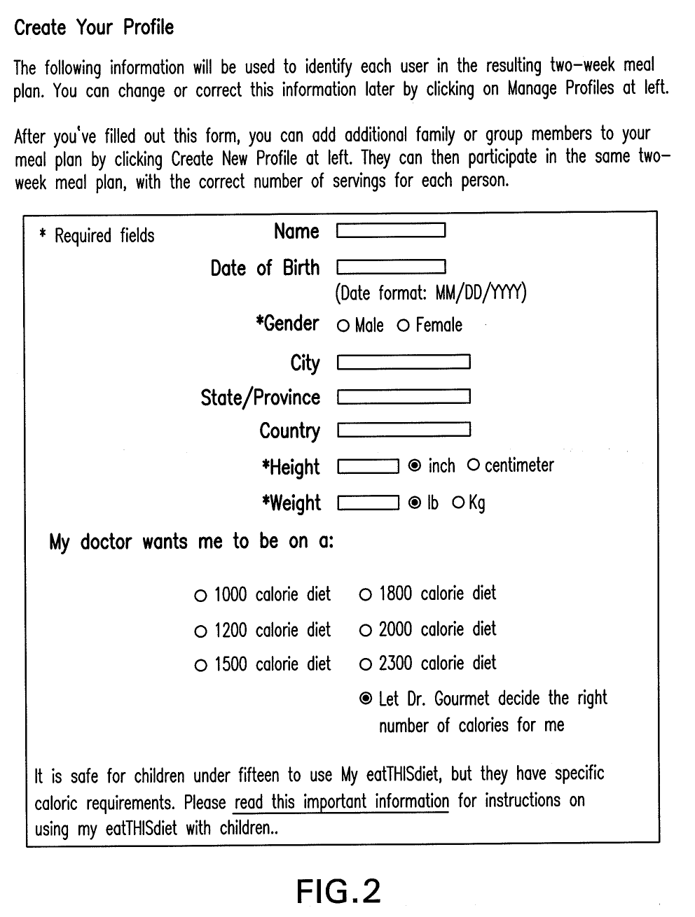

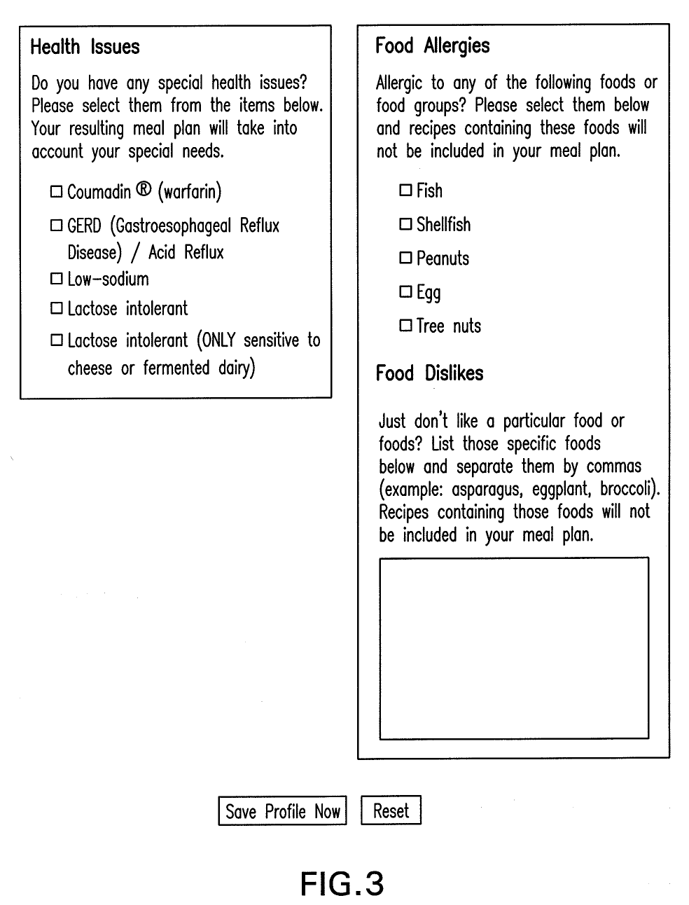

The system can provide various user functions. For example, as shown in FIG. 2 and FIG. 3, a user can enter demographic and anthropomorphic information including, but not limited to, User Name, User Password, User Password Confirmation, email address, Name, Date of birth, Gender, State/Province, Country, Height in inches or centimeters, Weight in pounds or kilograms, Health issues (including, but not limited to, Coumadin (warfarin) use, GERD (gastroesophageal reflux disease), Diabetes, Low-sodium, Gluten sensitive, Gout, Renal failure, Pregnancy, Cancer, Lactose intolerant, Lactose intolerant (only sensitive to cheese or fermented dairy)), Personal preferences, Food allergy (including, but not limited to, Fish, Shellfish, Peanuts, Egg, Tree nuts, Soy), Food aversion (including, but not limited to, asparagus, eggplant, peaches), Vegetarian, Lacto-ovo vegetarian, Vegan, Comfort foods, Non meat eater. A user can also enter other users information which can include the information above. The user can create and manage a group of users. A user can generate meal plans with shopping lists based on the demographic and anthropomorphic information in each group. The user can display meal plans, recipes, shopping lists, and equipment lists for printing and output to other devices including, but not limited to, mobile electronic devices such as smart phones, PDA's, laptops, and the like. This includes output to merchants such as grocery stores or purveyors of foodstuffs and equipment for collection and marketing of ingredients and equipment used in the meal plans. This may include delivery to or pick up by the user of the ingredients and/or equipment.

Users can be provided with a social network, also referred to as a “User Countertop.” The focus can be on a user social network of “Cooks” who are part of a “Cook's Circle.” A customizable web page can be provided that includes information about the user, fellow “Cooks” with links to their pages, access to their “Recipe Box” (entered recipes can be stored in a “recipe box” for users to share publicly or privately with other fellow Cooks), “My Pantry” (a feature that lets users enter their favorite ingredients and exchange information with other users about them), a “Through The Kitchen Window” messaging system (when a user is involved in a “Cook's Circle” they can exchange messages that are posted to a running commentary on a Cook's Countertop), a space for Kitchen Notes (blogging), and “My Equipment” (a feature that lets users enter their favorite equipment and exchange information with other users about them).

Users can also edit and enter their own recipes. Recipe entry can be configured for automatic calculation of Nutrition Facts and storage in the system.

Nutrition information can be calculated based on USDA National Nutrient Database for Standard Reference. Recipes can be made available through a user's Recipe Box and the user can share either publicly or privately with their Cook's Circle. Users can include recipes in the meal plan generation process if the recipe meets health criteria for inclusion.

Users can select alternative recipes during meal plan generation. The methods can generate a set of possible recipes for each individual meal. Those recipes form a list of alternative recipes for users. A user with adequate permissions, can select recipes for each meal from the list of alternative recipes. A drop down menu can permit a user to select a different breakfast, lunch, dinner or side dish recipe than the one selected by the system.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of meal plan generation software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data.

Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

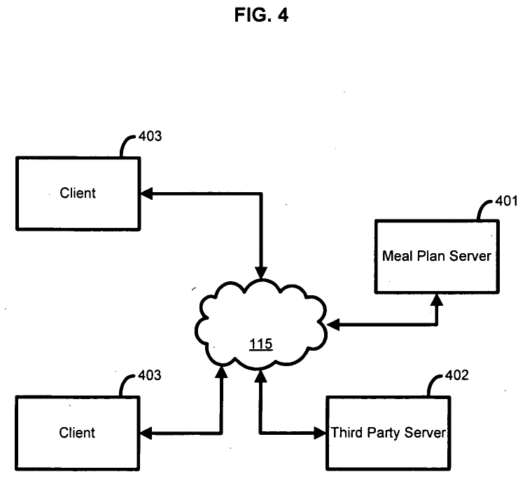

FIG. 4 illustrates an exemplary networked environment wherein the methods and systems disclosed can be practiced. All communication techniques used herein can optionally utilize varying levels of encryption to ensure privacy and prevent fraud. Various components can be in communication via a network such as network 115. These communications can take one or more forms of computer communication, for example, electronic mail, data mining, web-browsing, financial transactions, Voice Over IP, TCP/IP, any type of data transfer, and the like.

The Internet is based on a client/server architecture scheme, wherein some computers, such as user computers requesting or obtaining information, act as clients, and other computers, such as the computers which contain (or otherwise provide access to) the requested information, act as a servers. Users who are operating a browser request information, or data content, from the server. A browser is a computer program which enables the user to view information or files communicated over the Internet. The server responds and provides the content to the browser, barring any restrictions. The browser, in turn, provides the requested information to the user.

A server is typically a remote computer system accessible over a remote network such as the Internet. The client process may be active in a first computer system, and the server process may be active in a second computer system, communicating with one another over a communications medium, thus providing distributed functionality and allowing multiple clients to take advantage of the information-gathering capabilities of the server.

Client and server communicate with one another utilizing the functionality provided by a protocol layer. For example, Hypertext-Transfer Protocol (HTTP) is a common protocol that is used in conjunction with the World Wide Web (WWW).

Typically, a computer network address such as a Universal Resource Locator (URL) or an Internet Protocol (IP) address is used to identify the server or client computers to each other. The network address can be referred to as a URL address. For example, communication can be provided over a communications medium.

Various computing languages and standards can be used to permit communication between the client and the server. Examples include, but are not limited to, SSL/HTTPS, PHP, WSDL, BPEL, VXML, SSML, ASP, CSS, DHTML, SSI, XML, JavaScript, CGI, HTML, Cold Fusion Markup Language, RSS, SOAP, JSP, OWL, XHTML, ASP.NET, XSLT, AJAX, Perl, JAVA. These languages and standards can allow access to files and programs over the Internet. These languages and standards can also define a document format for web pages and further allow links to be specified to and from web pages to other web pages, web sites, servers and files. Links are programming features included in a web page and, upon activation, direct other content, such as a further web page or web site, to the user computer. Links may include, for example, indicia displayed as part of the content page and may be activated by the user, such as through a mouse button, keyboard or other user-input device. Thus, web pages on web sites may include links which, in effect, direct the movement of users to other web sites, content locations or pages and allow users to quickly jump from page-to-page or site-to-site. In addition, browsers typically include programming functions that allow a user to jump, for example, back or forward through pages or sites that the user had previously accessed, or to favorite web sites, home pages or the like.

In one aspect, the methods and systems provided can be based on client/server architecture. Both clients and servers can comprise components as described for computer 101. For example, a meal plan server 401 and a third party server 402 can support a server operating system. One or more clients 403 can utilize a web browser to communicate with, and access content on, the meal plan server 401. This communication can facilitate the generation of a meal plan. This communication can be through a network such as the Internet 115. Meal plan server 401 can maintain a database of data relating meal plan generation. Meal plan server 403 can further analyze data received from a user through client 403 and generate a meal plan. Meal plan server 403 can communicate with software resident on one or more third party servers 402. Third party server 402 can be under the control of a grocery store, cooking equipment retailer, and the like. This communication can facilitate transfer of data (such as, ingredient data, equipment data, and the like) to be used by the third party for offering/selling/shipping goods to a user. One or more clients 403 can utilize a web browser to communicate with, and access content on, the third party server 401.

In one aspect, provided are methods that allow users the ability to enter demographic and anthropomorphic data along with food preferences and health issues or allergies and select recipes and/or generate a meal plan based on the information.

In one aspect, meal plans can be created based on the number of servings of multiple individuals sorted to breakfast, lunch and dinner based on the nutritional and health requirements of the users. In some aspects, leftovers can be sorted to appropriate breakfasts, lunches and dinners based on specified information.

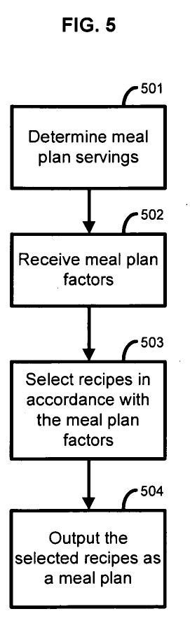

In one aspect, illustrated in FIG. 5, provided are methods for dynamic meal plan generation comprising determining meal plan servings at 501, receiving meal plan factors at 502, selecting recipes in accordance with the meal plan factors at 503, and outputting the selected recipes as a meal plan at 504.

In an aspect, determining meal plan servings can comprise determining an Ideal Body Weight (IBW) for a user. A conversion from Metric to English may be necessary in some instances. For male users: 106 lb for the first 5 ft; 6 lb for each inch over 5 ft. For female users: 100 lb for the first 5 ft; 5 lb for each inch over 5 ft.

After the IBW is determined, estimated optimum calories required to maintain weight can be determined. This can be determined, for example, by Ideal Body Weight×11. If the user is currently at the IBW, then the methods can assign a diet closest to their estimated caloric requirement. If the user is above the IBW the methods can assign the user to a weight loss plan [(IBW*11)−300]. That is, weight loss for those over IBW will be 300 calories less than that required for weight maintenance. In some aspects, total calories should not be less than 1200 even though a 1000 calorie diet is available as a user choice. Then, servings can be assigned for each meal based on the caloric determination. For example, for 1000 calories: Breakfast—1 serving, Lunch—1 serving, Dinner 1 serving. For 1200 calories: Breakfast—1 serving, Lunch—2 servings, Dinner 1 serving. For 1500 calories: Breakfast—2 servings, Lunch—2 servings, Dinner 1 serving. For 1800 calories: Breakfast—2 servings, Lunch—2 servings, Dinner 1 ½ servings. For 2000 calories: Breakfast—2 servings, Lunch—2 servings, Dinner 2 servings. For 2300 calories: Breakfast—2 servings, Lunch—3 servings, Dinner 2 servings.

The methods can multiply the servings per calorie meal by the following:

BW*2 and add fruit; BMF*5 and add fruit; D<45*7 (SVG<2, DIV by 2); L*7 (may be LO or LOS). Breakfasts can be selected (BW*2, BMF*5), add fruit.

Dinners can be selected [D<45*7 (SVG<2, DIV by 2)]. When selecting dinners, a specific number of recipe types can be applied, or recipes can be selected randomly.

For example, six fish recipes per two week cycle, two red meat recipe per two week cycle, two poultry per two week cycle, two meatless meals per two week cycle, and the like.

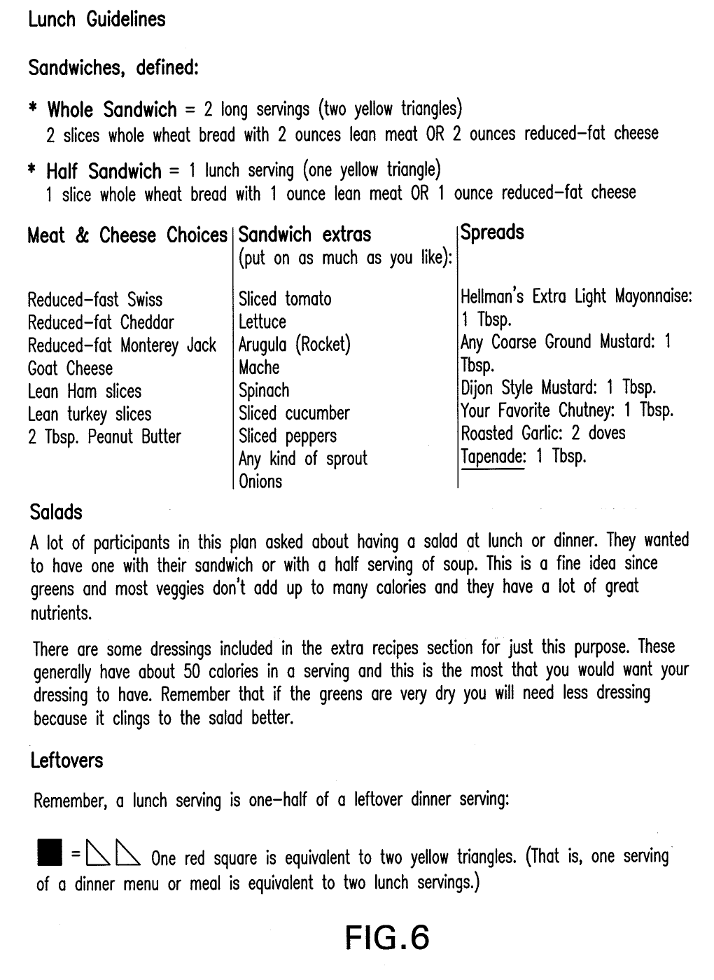

The methods can select lunches and add fruit. In an aspect the methods can use LO or LOS first on the days after dinners and fill in remaining days with sandwiches. The methods can assign x numbers of slices of bread, y numbers of ounces of sliced meat and z numbers of pieces of fruit. Lunch guidelines can be provided, such as that indicated in FIG. 6.

In an aspect, the user can add activity levels depending on work type and exercise patterns. This function increases the number of calories in the menu plan for that individual based on the type of activity. For example, a user is a jogger and enters their weekly hours of jogging. Information is drawn from a database of known caloric expenditure for exercises based on type of exercise, gender, age, height, weight and duration of exercise and adds the result to the caloric requirements divided either evenly throughout the week or on particular days depending on user requirements and exercise pattern. In another aspect, for users under the age of 16 the system can automatically choose a 1500 calorie diet plan and add in appropriate snacks based on user age and activity levels. Exercise caloric expenditure can be taken from the database as noted previously.

The methods can further comprise adding additional users to create meal plans for groups. If there is more than one user participating, demographic information can be taken for each user (except for the login information), the methods can be repeated as for the individual user up to the point of selecting individual recipes. Recipes can be selected for any number of servings for diet plans that have multiple participants. On the weekend D>45 meals can be selected and preference given to those recipes that make four or more servings so that multiple leftovers are created.

In an aspect, receiving meal plan factors can comprise receiving one or more of the following, user health considerations, user allergies, user preferences, user food dislikes, and the like. Health considerations can be used in meal plan creation.

In one aspect, each recipe can be tagged for a particular health issue. Examples include, but are not limited to, COUM-Coumadin (warfarin) user, GERD-Gastroesophageal Reflux Disease, DIAB-Diabetes, SOD-Low-sodium, GOUT-Gout, PREG-Pregnancy, CANC-Cancer, RENL-Renal Failure Diet, IBS-Irritable Bowel Syndrome, and the like. In another aspect, information contained in a “Nutrition Facts” list can be used by the system to select recipes. In this way, a maximum amount of a particular macronutrient or micronutrient cannot be exceeded for a given day based on a user's profile. In yet another aspect, a master list of ingredients for a particular condition can be entered. No recipe can be selected if it contains one of those ingredients.

For example, after the total number of servings is calculated for all participants the breakfasts, dinners and lunches can be selected by the same criteria as for a single person and then any recipes that are contrary to a user's health issues are not picked by the system. In another example, if one user is lactose intolerant and another is on Coumadin, the system can consider that all users are both lactose intolerant and on Coumadin. This can be used for any allergies, health restrictions and personal preferences. In another example, a Coumadin (warfarin) user can have a maximum amount of Vitamin K in each day's menu that the system is programmed to not exceed. Other examples include sodium for those on low or very low sodium diets, low-fat, low cholesterol and low potassium. Another example is GERD. Ingredients such as onions, peppers, chili peppers, chili powder can be entered into a GERD ingredients list. The system will not pick recipes that contain such ingredients for a user designated as having GERD (gastroesophageal reflux disease).

User allergies can be used in meal plan generation. In an aspect, each recipe can be manually tagged for a particular allergy. Examples include, but are not limited to, LACT-Recipe Contains Lactose, CHEESE-Recipe Contains Cheese or fermented dairy only, GLUT-Recipe Contains Gluten, FISH-Recipe Contains Fish, SHEL-Recipe Contains Shellfish, PNUT-Contains Peanuts, TREE-Contains Tree Nuts, SOY-Contains Soy Products. In another aspect, information contained in the “Nutrition Facts” list may be used by the system to pick recipes. In this way a maximum amount of a particular macronutrient or micronutrient cannot be exceeded for a given day based on a user's profile. In another aspect, a master list of ingredients for a particular allergy can be maintained. No recipe can be picked by the system if it contains one of those ingredients.

For example, after the total number of servings is calculated for all users the breakfasts, dinners and lunches can be selected by the same criteria as for a single user and then any recipes that are contrary to a user's allergies are not picked by the system. In another example, if one user has a soy allergy and another user is on Coumadin, the system will consider that all users are both allergic to soy and on Coumadin. This can be implemented for any allergies, health restrictions and personal preferences. In another example, if a user has Galactosidase Deficiency, the system can be setup not to select any recipes that contain more than a particular threshold of that micronutrient. In another example, with a user having a peanut allergy, any recipe that contains peanuts or any peanut byproduct would not be selected by the system.

User food preferences and dislikes can be used in meal plan generation. The system can permit users to enter food dislikes and/or food preferences. Any ingredient entered by a user that corresponds to an ingredient in a particular recipe will either be eliminated or preferred in a recipe from being selected. For example, if a user enters “onions, liver” as food dislikes, no recipes that contain onions (including green onions, red onions, onions) or liver (including calves liver, chicken livers, beef liver) will be selected for use in menus.

Selecting recipes in accordance with the meal plan factors can comprise selecting breakfast recipes, lunch recipes, and dinner recipes. Selecting breakfast recipes can comprise making a list of all (BW or BMF) breakfast recipes with all possible servings sizes for each recipe with LO or LOB checked. For example, if recipe r1 has SVG=2, MULT=2,3 and DIV=2, then r1 can have 4 possible servings sizes. SVG=2, SVG*MULT(2)=4, SVG*MULT(3)=6 and SVG/DIV=1. In this way a list of one or more breakfast recipes can be generated. From that list, a recipe can be randomly selected if tagged BMF whose serving size (one of its all possible serving sizes) matches most close to total breakfast serving size or is greater than the serving size but is tagged LO or LOB (or BOTH). If it is a weekend meal, then only that recipe tagged BW will be randomly selected whose serving size (one of its all possible serving sizes) matches most closely the total breakfast serving size or is greater than the total breakfast serving size but is tagged LO or LOB (or BOTH). If the result is that no recipe is selected, then system can select a breakfast recipe with SVG equal to total breakfast servings. If the result is that still no recipe is selected, then the system can select a breakfast recipe where its SVG divided by its DIV (if DIV is not equal to zero) is exactly equal to total breakfast servings. If a recipe is still not selected, then the system can select a breakfast recipe whose SVG multiplied by its MULTs (MULT contains information like 2,3,4—so for SVG*2, SVG*3 and SVG*3 each cases will be considered) is exactly equal to total breakfast servings. During the preceding recipe selection, the system can be configured to not include a previously used breakfast recipe. If the result is that no recipe is ultimately selected, then the method can repeat, however, using only previously used breakfast (BW or BMF) recipes. If still, no recipe exists that meets the selection criteria, the system can insert an appropriate wording such as X Breakfast Servings (where X=the number of servings of breakfast for that particular day). The wording can be an active link that leads to a web page explaining how to create “standby breakfasts” suitable for the meal plan.

Selecting lunch recipes can comprise making a list of all lunch recipes with all possible servings sizes for each recipe with LO or LOS checked. For example if recipe r1 has SVG=2, MULT=2,3 and DIV=2, then r1 can have 4 possible servings sizes viz. SVG=2, SVG*MULT(2)=4, SVG*MULT(3)=6 and SVG/DIV=1. In this way a list of one or more lunch recipes will be generated. From that list, a recipe can be randomly selected if tagged L with a serving size (one of its all possible serving sizes) matching most closely to total lunch serving size or is greater than the serving size but is tagged LO or LOS (or BOTH). If a recipe is not selected, then the system can select a lunch recipe with SVG is exactly equal to total lunch servings. If a recipe is still not selected, the system can select a lunch recipe with SVG divided by its DIV (if DIV is not equal to zero) is exactly equal to total lunch servings. If a recipe is still not selected, then the system can select a lunch recipe where SVG multiplied by its MULTs (MULT contains information like 2,3,4—so for SVG*2, SVG*3 and SVG*3 each cases will be considered) is exactly equal to total lunch servings. During the preceding recipe selection, the system can be configured to not include a previously used lunch recipe. If the result is that no recipe is ultimately selected, then the method can repeat, however, using only previously used lunch recipes. If still, no recipe exists that meets the selection criteria, the system can insert an appropriate wording such as X Lunch Servings (where X=the number of servings of Lunch for that particular day). The wording can be an active link that leads to a web page explaining how to create “standby lunches” suitable for the meal plan.

Selecting dinner recipes can comprise making a list of all dinner recipes with all possible servings sizes for each recipe with LO or LOS checked. For example if recipe r1 has SVG=2, MULT=2,3 and DIV=2, then r1 can have 4 possible servings sizes viz. SVG=2, SVG*MULT(2)=4, SVG*MULT(3)=6 and SVG/DIV=1. In this way a list of one or more dinner recipes will be generated. From that list a recipe cab be randomly selected if tagged D<45 whose serving size (one of its all possible serving sizes) matches most close to total dinner serving size or is greater than the serving size but is tagged LO or LOB (or BOTH). If it is a weekend meal, then from that list only that recipe tagged D>45 will be randomly selected whose serving size (one of its all possible serving sizes) matches most closest is equal to the total dinner serving size or is greater than the total dinner serving size but is tagged LO or LOS (or BOTH). If a recipe is not selected, then the system can select a dinner recipe whose SVG is exactly equal to total dinner servings. If a recipe is still not selected, the system can select a dinner recipe whose SVG divided by its DIV (if DIV is not equal to zero) is exactly equal to total dinner servings. If a recipe is still not selected, then the system can select a dinner recipe whose SVG multiplied by its MULTs (MULT contains information like 2,3,4 —so SVG*2, SVG*3 and SVG*3 each cases will be considered) is exactly equal to total dinner servings. During the preceding recipe selection, the system can be configured to not include a previously used dinner recipe. If the result is that no recipe is ultimately selected, then the method can repeat, however, using only previously used dinner (D<45 or D>45) recipe. When a dinner recipe is selected, the system can fetch that recipe whose serving size either exactly matches the total dinner serving size or multiples of total dinner servings size with LO checked on or greater than total dinner servings with LOS checked on. For example, if a dinner serving size is 3, then a dinner recipe with LO checked on, will only be selected if it is able to serve 3 or 3*2=6, 3*3=9, 3*4=12 (and so on) servings.

The methods can further comprise side dish selection. After recipes are selected, side dishes can be selected (if a side dish is required to complete a meal). In one aspect, side dishes can be served in the same number of servings as a users breakfast/lunch/dinner servings. Side dishes are subject to the same health and user preference criteria as all other recipes.

The methods can further comprise handling leftovers. For example, if an amount of servings required by group=x, then the number of recipe servings can comprise those that equal base servings or those using a multiplier designating the number of times a recipe can possibly be multiplied. For example, a maximum number of nights of leftovers can equal one (two nights total dinners from one recipe) and then recipes labeled LO and LOS can be sorted to lunch. If x=number of recipe servings in a recipe selected, then that recipe can be for a single night's dinner. If the number of recipe servings=[x*2] and is labeled LO, that recipe can be selected for two nights of meals. Only if the number of recipe servings=[x+(x−1)] and the recipe is labeled LO and LOS, then the recipe can be sorted to a single night with the remaining being used for [x*2] lunch servings. Only if the Number of recipe servings=[x*3] and the recipe is labeled LO and LOS, then the recipe may be sorted to two nights leftovers with the remaining being used for [x*2] lunch servings.

In one aspect, the system can be configured such that at no time will the system choose a recipe that would make the number of recipe servings greater than [x*3]. This can restrict the system to a maximum of two nights leftovers with leftovers for subsequent lunches. Only if the Number of recipe servings=[x+(x−1)] and the recipe is labeled LO and LOS, then the recipe can be sorted to a single night with the remaining being used for [x*2] lunch servings. Only if the Number of recipe servings =[x*3] and the recipe is labeled LO and LOS, then the recipe can be sorted to two nights leftovers with the remaining being used for [x*2] lunch servings.

For example, leftovers can be sorted to dinner meals the next day or second day if there are enough servings. This would be instead of using the leftovers at lunch. If there are two participants and a dish makes four servings, two are used on day one and two used on day three. If one participant is allowed one serving and the other two servings, however, then the forth serving would be allocated to lunch servings.

In another example, when the leftovers are sorted for lunch they can be sorted in whole servings. For example, if one user gets two servings for lunch this is equal to one leftover dinner serving and they would eat the whole serving. This sorts until the leftovers are used up and any remainder can be listed as eating from a sandwich instruction sheet. For example, ½ sandwich can equal one lunch serving.

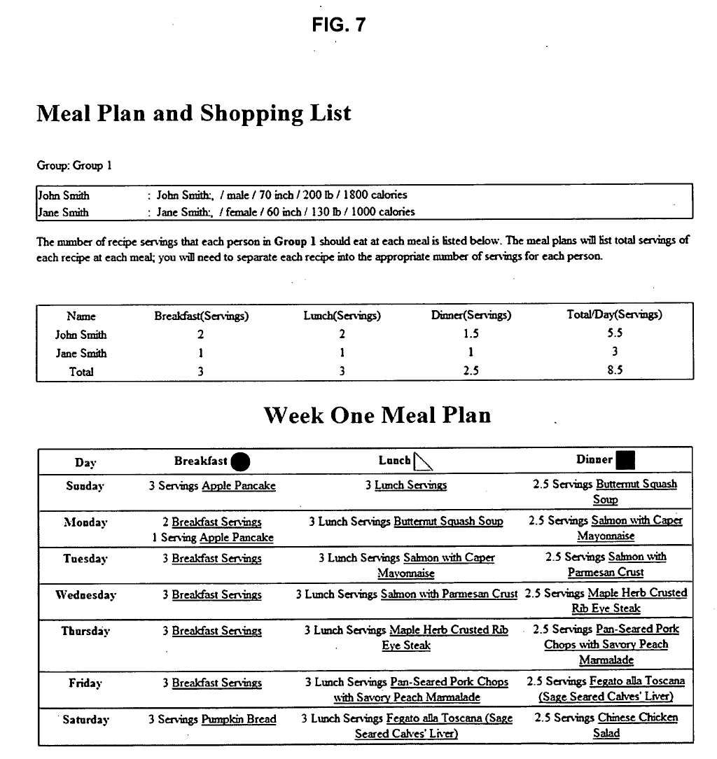

In an aspect, outputting the selected recipes as a meal plan can comprise displaying the meal plan on a display device. An exemplary meal plan is shown in FIG. 7. The meal plan can be in a calendar format and can have active links to each individual recipe or information about Breakfast Servings, Lunch Servings, and/or Dinner Servings. The meal plan can be based on a time period. For example, the meal plan can be generated for one day, multiple days, one week, multiple weeks, and so on. This allows for flexibility in the meal plan. For example, there can be an alternation between a total of three poultry and three meatless meals in a two week rotation (that is two poultry week one and one poultry week two with one meatless week one and two meatless week two). Leftovers that might occur on a Friday or Saturday can be stored in the database to be added to a new two week cycle and sorted to Monday or Tuesday the following week. Furthermore, recipe selection can be affected by the time period. For example, selecting recipes based on ingredients. If fresh dill is used in a recipe on Tuesday it would be good for it to also be used again on Thursday and Sunday to keep such ingredients from going to waste.

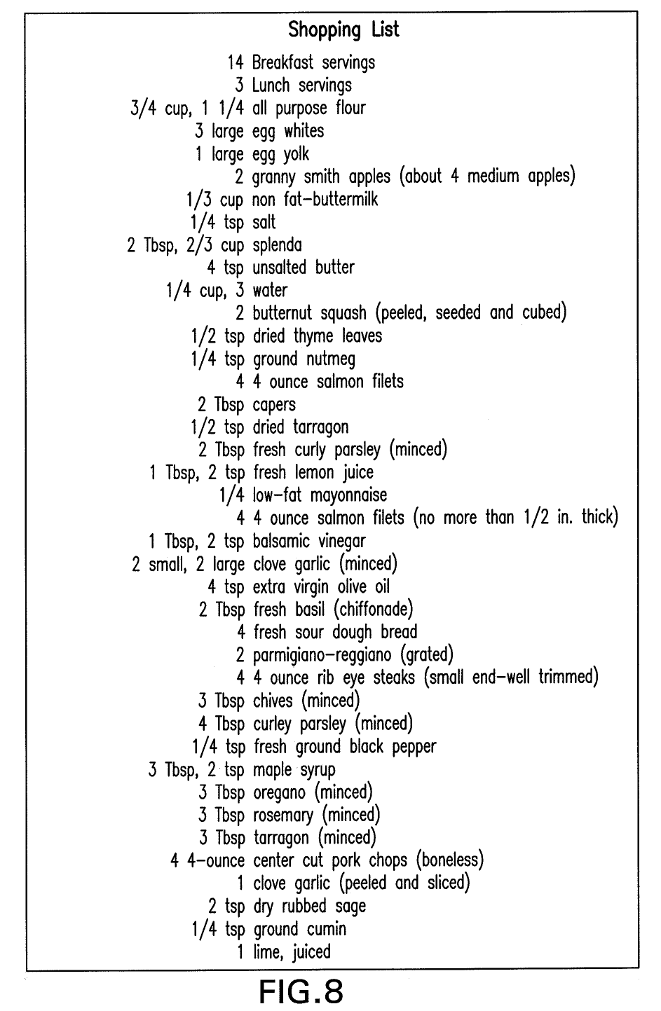

The methods can further comprise outputting a shopping list. An exemplary shopping list is shown in FIG. 8. Outputting a shopping list can comprise displaying the shopping list on a display device. The shopping list can be in a format that lists foods needed to create recipes and their amounts. For example, 1 medium, ½ medium, 1 large Onion. Shopping lists can be grouped with each of a week's menu plans and can be grouped by a section of the grocery store where the ingredient is found. For example, Produce Section: 1 medium, ½ medium, 1 large Onion; 1 Red Bell Pepper; 1 Cucumber. Checkboxes, or other indicator, can be provided next to each line to indicate that an item is needed for purchase that a user does not already possess. A default state can be that the checkbox is checked and users uncheck to indicate they do not need a particular item. A “Print Shopping List” feature can print or output to mobile device or third party only those items that are checked. In an aspect, the shopping list can be output to a grocery store (either brick & mortar, or online) to have the items gathered for the user and in some aspects delivered to the user.

The methods can further comprise outputting an equipment list. Outputting a equipment list can comprise displaying the equipment list on a display device. The equipment list can be in a format that lists equipment needed to create recipes. For example, 1 medium mixing bowl, 1 rubber spatula, 1 medium whisk. Equipment can be listed as an active link to an equipment glossary. In an aspect, orders for equipment can be placed directly from the glossary. Checkboxes, or other indicator, can be provided next to each line to indicate that a piece of equipment is needed for purchase that a user does not already possess. A default state can be that the checkbox is unchecked and users check to indicate they need a particular item. A “Print Equipment List” feature can print or output to mobile device or third party only those items that are checked. In an aspect, the shopping list can be output to an equipment store (either brick & mortar, or online) to have the items gathered for the user and in some aspects delivered to the user.

The methods can further comprise outputting to a mobile device. For example, meal plans, shopping lists, and equipment lists can be output as a tab delimited text file, a comma separated value file, a spreadsheet, and the like. The output can be to a mobile device such as a smart phone, a PDA, a laptop, and the like. Output can take place through a direct wired connection or wirelessly.

The methods can further comprise outputting to a third party. As indicated previously, meal plans, shopping lists, and equipment lists can be output to third party purveyors including, but not limited to, grocery stores and retailers of cooking equipment. An interface can be provided to communicate directly with inventory picking on site of the retailer for delivery to or pick up by the user.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A computer implemented method for dynamic meal plan generation comprising:
determining meal plan servings, for one or more users;
receiving meal plan factors, for the one or more users;
selecting recipes in accordance with the meal plan factors; and
outputting the selected recipes as a meal plan.

2. The method of claim 1, wherein determining meal plan servings comprises determining an Ideal Body Weight (IBW) for a user.

3. The method of claim 1, further comprising, after the IBW is determined, determining a caloric requirement.

4. The method of claim 3, wherein if the user is currently at the IBW, assigning the user to a weight maintenance plan.

5. The method of claim 3, wherein if the user is above the IBW, assigning the user to a weight loss plan.

6. The method of claim 3, wherein determining meal plan servings further comprises assigning servings for a plurality of meals based on the caloric requirement.

7. The method of claim 1, wherein receiving meal plan factors comprises receiving one or more of, user health considerations, user allergies, user preferences, and user food dislikes.

8. The method of claim 1, wherein selecting recipes in accordance with the meal plan factors comprises selecting a breakfast recipes, a lunch recipe, and a dinner recipe.

9. The method of claim 8, wherein each recipe is tagged for one or more of, a health issue, an allergy, and a user preference.

10. The method of claim 1, further comprising receiving a user activity level and adjusting the caloric requirement based on the user activity level.

11. The method of claim 1, further comprising predicting a user's leftovers and adjusting recipe selection based on the predicted leftovers.

12. The method of claim 1, wherein outputting the selected recipes as a meal plan comprises displaying the meal plan on a display device

13. The method of claim 1, further comprising outputting a shopping list.

14. The method of claim 1, further comprising outputting an equipment list.

15. A system for dynamic meal plan generation comprising:
a memory, configured for storing meal plan generation data; and
a processor, configured for performing steps comprising,
determining meal plan servings, for one or more users,
receiving meal plan factors, for the one or more users,
selecting recipes in accordance with the meal plan factors, and
outputting the selected recipes as a meal plan.

16. The system of claim 15, wherein determining meal plan servings comprises determining an Ideal Body Weight (IBW) for a user.

17. The system of claim 15, further comprising, after the IBW is determined, determining a caloric requirement.

18. The system of claim 15, wherein receiving meal plan factors comprises receiving one or more of, user health considerations, user allergies, user preferences, and user food dislikes.

19. A computer readable medium having computer executable instructions embodied thereon for dynamic meal plan generation comprising:
determining meal plan servings, for one or more users;
receiving meal plan factors, for the one or more users;
selecting recipes in accordance with the meal plan factors; and
outputting the selected recipes as a meal plan.

20. The computer readable medium of claim 19, wherein receiving meal plan factors comprises receiving one or more of, user health considerations, user allergies, user preferences, and user food dislikes.
